(19) United States
(12) Patent Application Publication
(10) Pub. No.: US 2024/0201997 A1
(43) Pub. Date: Jun. 20, 2024

(54) ENHANCED OFFLOAD TO HARDWARE ACCELERATORS

(71) Applicant: TEXAS INSTRUMENTS INCORPORATED, Dallas, TX (US)

(72) Inventors: Mihir Mody, Bangalore (IN); Kedar Chitnis, Bangalore (IN); Prithvi Shankar Yeyyadi Anantha, Bangalore (IN); Shailesh Ghotgalkar, Bangalore (IN); Donald Steiss, Richardson, TX (US); Mohammad Asif Farooqui, Bangalore (IN); Nikhil Sangani, Bangalore (IN); Sriraj Chellappan, Bangalore (IN)

(21) Appl. No.: 18/068,030

(22) Filed: Dec. 19, 2022

(51) Int. Cl. G06F 9/345; G06F 9/30; G06F 9/38; G06F 9/50

(52) U.S. Cl. CPC G06F 9/345; G06F 9/30021; G06F 9/3877; G06F 9/5016; G06F 9/5027

(57) ABSTRACT

Various embodiments disclosed herein relate to compute offloading by supplying operands to hardware accelerators from central processing units. An example embodiment includes a system configured to perform compute offloading. The system comprises a processing unit configured to write data to a memory and a memory adaptor bridge coupled between the processing unit and the memory. The memory adaptor bridge is configured to, in response to an attempt by the processing unit to write an operand to a memory location mapped to a function of a hardware accelerator, write the operand to a different memory location accessible by the hardware accelerator. The memory adaptor bridge is further configured to obtain a result of the function performed on the operand by the hardware accelerator and provide the result of the function to a memory location accessible by the processing unit.

### TECHNICAL FIELD

The technology disclosed herein generally relates to offloading computational operations from processors to hardware accelerators.

### BACKGROUND

Many computing applications benefit from offloading domain specific operations or instructions like sin, cos, arctan, Park transform, or Clarke transform when they are not natively supported in an instruction set architecture (ISA) of a central processing unit (CPU). These types of operations may require a few clock cycles when hardware accelerated, as opposed to tens of cycles when implemented in software. Some known CPU ISAs do not allow ISA extension with, for example, co-processor hooks.

Some applications that use operations including those mentioned above may be safety-critical and require protection mechanisms. One example is lock-step modes as for Automotive Safety Integrity Level (ASIL)-D applications in the automotive industry. Operations such as those mentioned above may also need to run in a highly deterministic manner. Some examples of the latter case include real-time control schemes such as traction invertor, power conversion, and motor control applications.

### SUMMARY

Disclosed herein are improvements to compute offloading, and more particularly, to offloading operands from processing units to hardware accelerators in response to attempts by the processing units to write the operands to memory locations of functions mapped to the hardware accelerators. An example embodiment includes a system configured to perform compute offloading. The system comprises a processing unit configured to write data to a memory and a memory adaptor bridge coupled between the processing unit and the memory. The memory adaptor bridge may include a circuit configured to, in response to an attempt by the processing unit to write an operand to a memory location mapped to a function of a hardware accelerator, write the operand to a different memory location accessible by the hardware accelerator. The memory adaptor bridge is further configured to obtain a result of the function performed on the operand by the hardware accelerator and provide the result of the function to a memory location accessible by the processing unit.

This Summary is provided to introduce a selection of concepts in a simplified form that are further described below in the Detailed Description. It may be understood that this Summary is not intended to identify key features or essential features of the claimed subject matter, nor is it intended to be used to limit the scope of the claimed subject matter.

### BRIEF DESCRIPTION OF THE DRAWINGS

Embodiments of the present technology will be described and explained through the use of the accompanying drawings in which:

FIGS. 1A and 1B illustrate an example system configurable to perform compute offloading and an example representation of a memory map used to perform compute offloading in an implementation, respectively;

FIG. 2 illustrates a series of steps for offloading operations from a processing unit to a hardware accelerator;

FIG. 3 illustrates example sequential process flows of processing access requests by a processing unit according to an implementation;

FIG. 4 illustrates an example operating environment for offloading operations from a processing unit to multiple hardware accelerators;

FIG. 5 illustrates an example operating environment for offloading operations from a processing unit to multiple hardware accelerators;

FIG. 6 illustrates an example operating environment for offloading operations from multiple processing units to multiple hardware accelerators; and

FIGS. 7A and 7B illustrate example operating environments wherein components can perform compute offloading.

The drawings are not necessarily drawn to scale. In the drawings, like reference numerals designate corresponding parts throughout the several views. In some examples, components or operations may be separated into different blocks or may be combined into a single block.

### DETAILED DESCRIPTION

The present technology may be implemented to define and provide a compute offload scheme to extend an instruction set architecture (ISA) of one or more processing units. The disclosed apparatuses, systems, methods, and computer program products may be utilized for execution of offloaded computing operations in a safe and deterministic manner. The present technology improves upon conventional techniques like central processing unit (CPU) co-processors or known hardware accelerators with, for example, a lower required programming overhead, improved opportunities for customization, achieving determinism without strictly requiring instruction pre-emption, and more efficient handling of interrupts. The compute offloading processes and techniques disclosed herein can be scaled for use by a plurality of processing units, such as processing units within a CPU, or for multi-core CPUs, thereby facilitating highly efficient high-speed processing, including massively parallel processing, to achieve efficiencies in compute-intensive applications in a wide variety of industries ranging from autonomous vehicles, remote sensing, electric vehicle drivetrains, power generation, conversion, storage and transmission, artificial intelligence, and image processing, among other examples.

In the disclosed compute offload scheme, a hardware accelerator can implement a set of operations rather than the processing unit. The locations or registers in a memory may be memory-mapped to serve as processing unit-accessible memory in cases where designated operations are offloaded to the disclosed hardware accelerator. In this way, processing units may utilize the compute offload scheme directly with simple instructions that may already be included in the native CPU ISA. In some examples of the disclosed systems, apparatuses, methods, and computer program products, compute offload processes may be triggered when a processing unit attempts to write an operand to a specific location assigned to a hardware accelerator, or mapped to a function of the hardware accelerator. As such, this may provide improved efficiency compared to conventional techniques because, to the software, it appears like a typical memory write to a particular address, which may simply use a native ISA routine.

In various examples, once the compute offload of an operation is triggered, the hardware accelerator performs the computation, and a memory adaptor bridge coupled to both the processing unit and the hardware accelerator can read the results from a memory location accessible by the hardware accelerator and write the results to a different memory location accessible by the processing unit. In some cases, the processing unit may wait for a predetermined number of CPU clock cycles for the hardware accelerator to finish performing the computation (e.g., using NOP instructions to control delay). Alternately, the memory adaptor bridge can allow read access immediately from the memory location storing the result, and if the hardware accelerator has not completed the computation, the memory interface(s), bus(es) or other data communications means may be stalled until the result data is available, making it transparent to the application that supplied the software and avoiding additional instructions. A variety of customizations are readily made to the present technology without departing from the scope of the present disclosure, so as to provide a number of technically advantageous ways to quickly offload deterministic and/or safety critical operations from one or more processing units and/or CPUs with better and more power efficient usage of computing, communication, and memory resources.

The systems, apparatuses, methods, and computer program products for compute offloading according to the present technology also support multi-context and pipelined compute. In the multi-context case, different software contexts can use independent address-aliased operand and result registers without corrupting each other's operations and results. In the pipelined compute context, independent aliased operand and result registers enable the present technology to beneficially use a pipelined compute offload scheme and execute different operations every cycle with the result available in one or more independent result registers in pipelined fashion after a compute delay. Furthermore, the compute offload hardware and associated techniques can be readily adapted for both strongly ordered and non-strongly ordered CPU architectures. Interrupts can occur and are supported in the compute offload schemes enabled by the present technology. For example, lock-step modes can ensure safety by using two or more distinct hardware accelerators to perform computations. Where computing operations to be offloaded are not safety-critical, the compute offloading according to the present technology may proceed efficiently in other ways, such as: split mode where each processing unit in a cluster (i.e., cores in a single CPU) may employ individual ones of hardware accelerators, or double mode, where a single processing unit in a cluster can employ two or more hardware accelerators. Other combinations and/or variations thereof may be contemplated as well.

In one example, a system is provided. The system comprises a processing unit configured to write data to memory and a memory adaptor bridge coupled between the processing unit and the memory. In addition to handling memory accesses, the memory adaptor bridge is configured to, in response to an attempt by the processing unit to write an operand to a memory location mapped to a function of a hardware accelerator, write the operand to a different memory location accessible by the hardware accelerator; obtain a result of the function performed on the operand by the hardware accelerator; and provide the result of the function to a memory location accessible by the processing unit.

In another example, a method is provided. The method comprises a processing unit writing data to memory and a memory adaptor bridge, in response to an attempt by the processing unit to write an operand to a memory location mapped to a function of a hardware accelerator, writing the operand to a different memory location accessible by the hardware accelerator; obtaining a result of the function performed on the operand by the hardware accelerator; and providing the result of the function to a memory location accessible by the processing unit.

In yet another example, a memory adaptor bridge is provided that comprises first circuitry and second circuitry. The first circuitry is configured to, in response to an attempt by a processing unit to write an operand to a memory location mapped to a function of a hardware accelerator, write the operand to a different memory location accessible by the hardware accelerator. The second circuitry is configured to obtain a result of the function performed on the operand by the hardware accelerator and provide the result of the function to a memory location accessible by the processing unit.

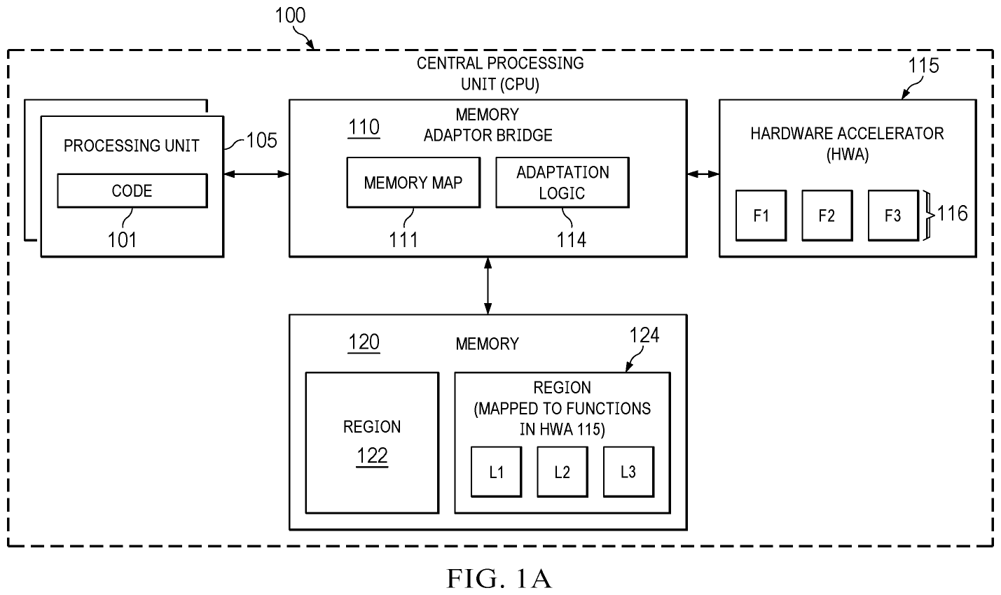

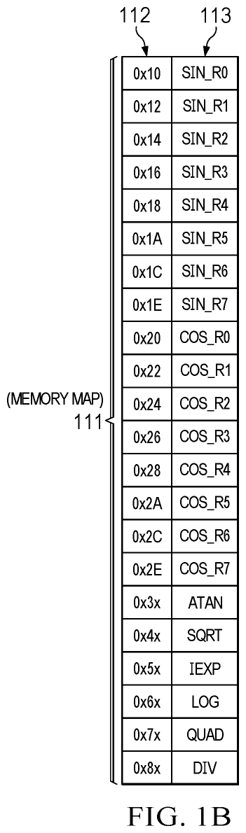

Turning now to the Figures, FIG. 1A illustrates an example system configurable to perform compute offloading. FIG. 1A shows central processing unit (CPU) 100, which includes processing unit 105, memory adaptor bridge 110, hardware accelerator (HWA) 115, and memory 120. HWA 115 includes functions 116, shown as F1, F2, and F3. Memory 120 may include region 122 and region 124, wherein each of region 124 (L1, L2, and L3) can be mapped to individual ones of functions 116. Regions 122 and 124 may be representative of a range of memory locations in memory 120. In particular, region 124 includes a set of addresses that may be physically present in the memory 120 and correspond to actual data storage elements of the memory 120 or may be only virtually present in the memory 120 and correspond to registers within HWA 115 without having corresponding data storage elements in memory 120. In other words, the memory bridge adaptor 110 causes region 124 to appear to exist in the memory 120 from the CPU's perspective, but the corresponding data storage elements may or may not be present in memory 120. In that regard, memory bridge adaptor 110 is coupled between processing unit 105, HWA 115, and memory 120 and is configured to perform accesses of the memory on behalf of the processing unit 105 and to perform compute offloading processes using memory map 111 and adaptation logic 114. FIG. 1B illustrates an example representation of memory map 111 that can be used to implement compute offloading processes.

In CPU 100 of FIG. 1A, processing unit 105 is representative of one or more processing cores or nodes in a CPU system, configured to execute code 101 (e.g., instructions and data) to perform functionality enabled by code 101. In doing so, processing unit 105 attempts to access memory 120 to read from and write to locations of memory 120 to execute the code and data. Processing unit 105 may not, however, support some operations required to complete the execution of code 101. For example, native ISA of processing unit 105 may not support computations using some mathematical equations, or operands. Such operations may instead require the operands to be offloaded for computation by another processing device, hardware accelerator, or the like.

HWA 115 can be included in CPU 100 to perform computations not natively supported by or too complex for processing unit 105. HWA 115 can perform one or more functions (functions 116), such as trigonometric functions, differential equations, and time-invariant functions, among other computations and deterministic functions, on operands. To perform functions 116, HWA 115 may include circuitry, logic components, or the like specifically designed to produce a result of the function performed on the operand. In some instances, HWA 115 may be configured to perform only one function, however, in other instances, HWA 115 can be configured to perform any number of functions, such as F1, F2, and F3. Each of functions 116 can correspond to one or more registers (also referred to herein as locations or addresses) of memory 120. For example, functions 116 can be associated with locations in region 124 of memory 120. L1, L2, and L3 are representative of locations/addresses within region 124. L1 can be mapped to F1 of functions 116, L2 can be mapped to F2, and L3 can be mapped to F3. As such, region 124 of memory 120 can be memory-mapped in code 101 such that when processing unit 105 attempts to write an operand to one of region 124, HWA 115 can be triggered to perform a respective one of functions 116 on the operand to produce a result for use by processing unit 105. Instead of calling HWA 115 with a jump function, or another hard-coded call (e.g., via an interconnect), however, processing unit 105 can simply execute code 101, which is pre-configured and compiled with the memory mappings.

To offload such computations from processing unit 105 to HWA 115, memory bridge adaptor 110 is included and is coupled between processing unit 105, HWA 115, and memory 120. Memory bridge adaptor 110 can utilize memory map 111 and adaptation logic 114 to identify attempts from processing unit 105 to access locations in memory 120 (e.g., region 122 and region 124) and allow access to memory 120 unless processing unit 105 attempts to access one or more memory locations of region 124. In an instance where processing unit 105 attempts to write an operand to a register not mapped to HWA 115 (i.e., to one of region 122), memory bridge adaptor 110 allows processing unit 105 to write the operand to a location of region 122, and processing unit 105 can continue executing code 101. In an instance where processing unit 105 attempts to write an operand to a register mapped to a function of HWA 115 (e.g., L1 of region 124) per memory map 111, memory bridge adaptor 110 writes the operand to a location specified in memory map 111 accessible by HWA 115, obtains the result produced by HWA 115, and writes the result to a different register of memory 120. Then, processing unit 105 can read the result from memory 120 and continue to execute code 101 using the result. In either instance, however, to the application or peripheral that supplied code 101 to processing unit 105, the write/read activities appear as ordinary actions by processing unit 105.

In some cases, HWA 115, rather than memory adaptor bridge 110, may write the result of the function performed on the operand to a register. The register configured to store the result may be located in memory 120, or it can be external to memory 120. For example, HWA 115 may include a memory configured to store results of functions performed on operands. In such an example, memory adaptor bridge 110 can access the memory of HWA 115 to provide the results to processing unit 105 in response to an attempt by processing unit 105 to read the results.

In CPU 100, the components may be tightly coupled and interface with one another without the use of an interconnect. This may allow for deterministic compute offloading to HWA 115 at a fixed latency (e.g., approximately within one CPU clock cycle). Advantageously, operations can be offloaded from processing unit 105 to HWA 115 with increased speed as compared to offloading techniques that utilize an interconnect to interface with a peripheral hardware accelerator, for example. Further, such a system may allow processing unit 105 to execute code 101 using native protocols. However, under such protocols, code 101 may require processing unit 105 to wait a number of clock cycles after performing a write of an operand before performing a read of the same operand. This gives HWA 115 time (the number of CPU clock cycles) to perform a function on the operand. For example, code 101 can include no operation (NOP) instructions to delay a read from the register associated with the result. Alternatively, in other cases, HWA 115 can stall the bus of processing unit 105 until HWA 115 has completed performing a function on the operand and the result is ready.

In CPU 100, memory bridge adaptor 110 and/or hardware accelerator 115 can include one or more processors, logic, circuitry, and/or any combination or variation thereof. For example, memory bridge adaptor 110 includes adaptation logic 114 to enable compute offloading processes described herein. Such devices may be representative of analog and/or digital circuitry configured to direct various components of CPU 100 to function according to a logical scheme of operation. For example, adaptation logic 114 of memory adaptor bridge 110 and/or logic of HWA 115 may include a processor or controller having at least one fixed functionality, digital logic components (e.g., multiplexers, logic gates, comparators) to do fixed processing (e.g., sine, cosine, Clarke transform, Parke transform), and/or the like. In other examples, memory adaptor bridge 110 and/or HWA 115 may, at least in part, utilize program instructions encoded as software and/or firmware and stored in one or more memory storage devices for use by processor(s) to read, write and delete useful data, and to perform processor mediated arithmetical operations of various types to perform compute offloading processes described herein. Examples of such processor(s) may include microcontrollers, DSPs, general purpose central processing units, application specific processors or circuits (e.g., ASICs), and logic devices (e.g., FPGAs), as well as any other type of processing device, combinations, or variations thereof. Regardless, processor(s) utilized by components of described herein can be implemented within a single processing device or distributed across multiple processing devices or sub-systems that cooperate in executing program instructions.

Memory 120 may comprise any computer-readable storage media capable of being read and written to by memory adaptor bridge 110 and/or processing unit 105. Memory 120 may include volatile and nonvolatile, removable and non-removable media implemented in any method of technology for storage of information. For example, memory 120 may include random access memory (RAM), static RAM (SRAM), dynamic RAM (DRAM), double data rate (DDR), flash memory, tightly coupled memory (TCM), or any other type of memory or combination or variation thereof. Memory 120 may be implemented separately or in an integrated manner with respect to other types of memory.

FIG. 1B illustrates an example representation of memory map 111 used by adaptation logic 114 of memory adaptor bridge 110 to perform compute offloading in an implementation. Memory map 111 includes operand registers 112 and function registers 113. Memory map 111 represents a relationship between memory locations associated with functions of HWA 115 (e.g., locations in region 124), denoted as operand registers 112, and memory locations accessible by HWA 115 to where memory adaptor bridge 110 can write operands, denoted as function registers 113. The various function registers 113 may each be associated with a specific function to be performed by the HWA 115. Operand registers 112 and function registers 113 may exist in memory 120, the registers may exist in a different memory, such as one of HWA 115, or any combination or variation thereof.

In an example, in response to an attempt by processing unit 105 to write an operand to location 0x10 of operand registers 112, memory adaptor bridge 110 can write the operand to location SIN_R0 of function registers 113. SIN_R0 location may represent a memory register associated with a sine function performable by HWA 115. In another example, in response to an attempt by processing unit 105 to write an operand to location 0x20 of operand registers 112, memory adaptor bridge 110 can write the operand to location COS_R0 of function registers 113. COS_R0 may represent a memory register associated with a cosine function performable by HWA 115. Some functions may be associated with multiple locations of function registers 113, while other functions may be associated with one location. Upon memory adaptor bridge 110 writing an operand to one of function registers 113, HWA 115 can perform the associated function on the operand.

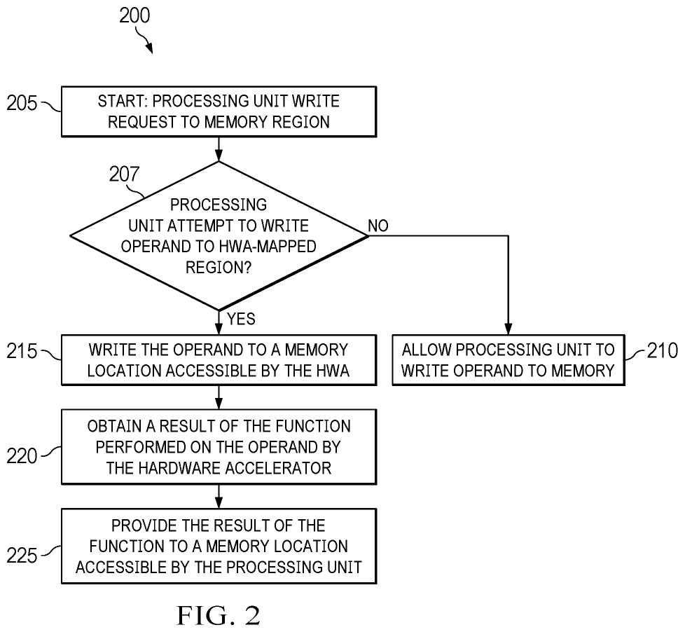

FIG. 2 illustrates a series of steps for offloading operations from a processing unit to a hardware accelerator. FIG. 2 includes process 200 described parenthetically below, which references elements of FIG. 1. Process 200 can be implemented on software, firmware, and/or hardware, or any combination or variation thereof. For example, CPU 100, and components thereof, of FIG. 1 can operate process 200.

Process 200 begins at operation 205 when processing unit 105 requests (205) to write an operand to a memory region. Processing unit 105 is coupled to memory adaptor bridge 110, which is configured to allow or prevent processing unit 105 from accessing memory 120. In operation 207, memory adaptor bridge 110 determines (207) whether the attempt by processing unit 105 is a write to an HWA-mapped region of memory 120 (e.g., region 124), or a memory location mapped to a function of HWA 115. If processing unit 105 attempts to write the operand to a memory location mapped to a function of HWA 115, memory adaptor bridge 110 writes (215) the operand to a memory location accessible by HWA 115. Memory adaptor bridge 110 is also coupled to HWA 115, such that when memory adaptor bridge 110 identifies the access attempt of the HWA-mapped region, memory adaptor bridge 110 can provide a signal to HWA 115 to act on the data memory adaptor bridge 110 writes to the memory location accessible by HWA 115.

In some instances, the memory location accessible by HWA 115 is a register or location of memory 120 other than the memory location that processing unit 105 attempts to write the operand to. In other instances, the memory location accessible by HWA 115 is a register located in a memory of HWA 115. Once memory adaptor bridge 110 writes the operand to this memory location, HWA 115 can perform one or more functions 116 on the operand. Functions 116 performable by HWA 115 may include trigonometric functions, differential equations, and time-invariant functions, among other computations and deterministic functions. To perform functions 116, HWA 115 may include circuitry, logic components, or the like specifically designed to produce a result of the function performed on the operand. After completing one of functions 116 on the operand, HWA 115 can store the result in a register. This register may be located in memory 120, or it can be located within a memory of HWA 115, among other memories.

In operation 220, memory adaptor bridge 110 obtains (220) the result of the function performed on the operand by HWA 115. In some instances, memory adaptor bridge 110 reads the register holding the result (e.g., on memory 120 or on memory of HWA 115) to obtain the result. In other instances, memory adaptor bridge 110 can obtain the result directly from HWA 115.

In operation 225, memory adaptor bridge 110 provides (225) the result of the function to a memory location accessible by processing unit 105. This may entail memory adaptor bridge 110 reading the result from one register and writing the result to a different register of a memory coupled to processing unit 105 (e.g., memory 120). For example, if the result is stored in a memory location of a memory on HWA 115, memory adaptor bridge 110 can write the result to a memory location of memory 120 accessible by processing unit 105. By way of another example, memory adaptor bridge 110 can allow processing unit 105 to access a register of HWA 115 to read the result. Regardless, after the result is accessible to processing unit 105, processing unit 105 can continue executing code 101. In some instances, however, processing unit 105 may be configured to delay a read of the result until a number of clock cycles have occurred or until HWA 115 has produced the result.

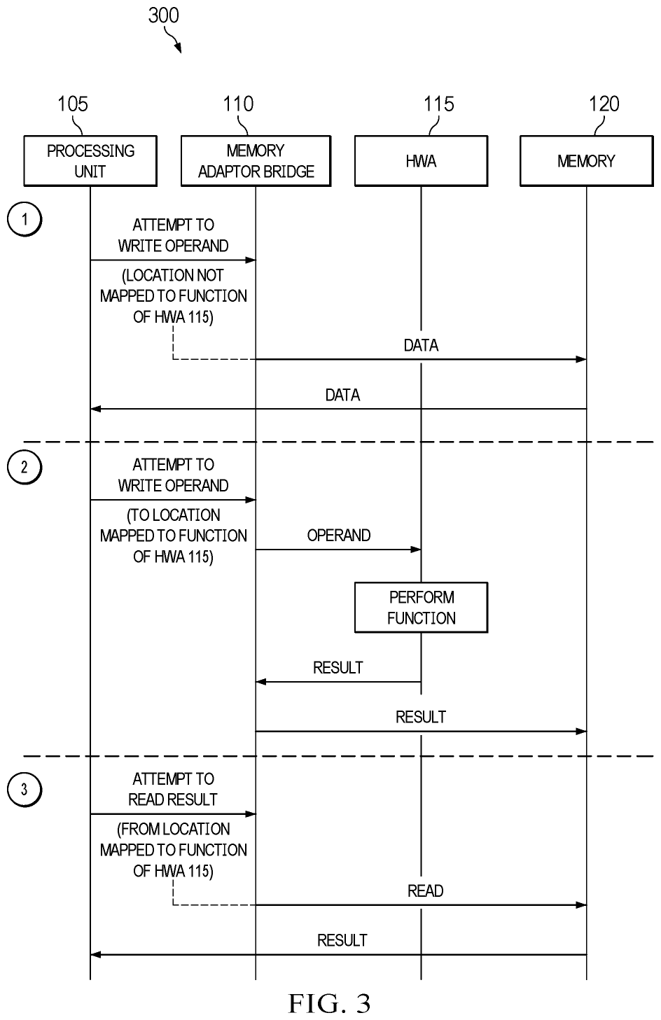

FIG. 3 illustrates example sequential process flows of processing access requests by a processing unit according to an implementation. FIG. 3 illustrates process flow 300, which demonstrates three operative scenarios for responding to requests by a processing unit. Process flow 300 references elements of FIG. 1, such as processing unit 105, memory adaptor bridge 110, HWA 115, and memory 120.

In scenario “1,” processing unit 105 executes code resulting in an attempt to access (e.g., read or write) memory 120. In this scenario, the location processing unit 105 attempts to access is not mapped to a function of HWA 115, so memory adaptor bridge 110 can allow access to memory 120. Accordingly, if the attempt by processing unit 105 does not involve a function of HWA 115, memory adaptor bridge 110 allows processing unit 105 to read from and write to memory 120 as processing unit 105 would ordinarily be able to do during the execution of code.

In scenario “2” of process flow 300, processing unit 105 executes code resulting in an attempt to write an operand to memory 120. However, the location that processing unit 105 attempts to access is mapped to a function of HWA 115. Memory adaptor bridge 110, coupled between processing unit 105, HWA 115, and memory 120, identifies that processing unit 105 attempts to write to a location mapped to a function of HWA 115, and in responding to the attempt, writes the operand to a different location accessible by HWA 115 instead of allowing processing unit 105 to write the operand to the initially intended location in memory 120. HWA 115 may include circuitry or logic blocks configured to perform the function on the operand. HWA 115 uses such circuitry to perform the function on the operand supplied by memory adaptor bridge 110 and produces a result. Memory adaptor bridge 110 then reads the result from HWA 115. In some cases, memory adaptor bridge 110 may obtain the result from a memory of HWA 115, or it may be fed the result from the circuitry of HWA 115. Then, memory adaptor bridge 110 writes the result to a further location accessible by processing unit 105, such as a location in memory 120.

In scenario “3,” processing unit 105 executes code resulting in an attempt to read a result from memory 120, or another location accessible by processing unit 105. The location processing unit 105 attempts to access is mapped to the function of HWA 115. And in this scenario, processing unit 105 attempts to read the result produced in scenario “2”. Memory adaptor bridge 110 allows the read from memory 120, and thus, processing unit 105 can obtain the result from memory 120 and continuing executing code.

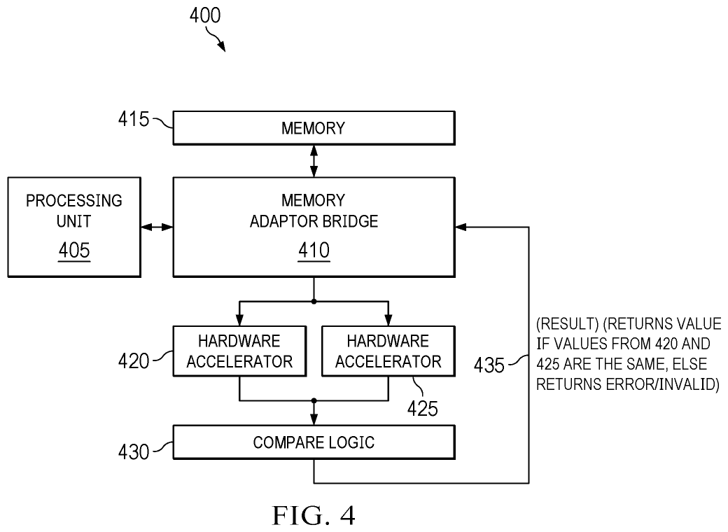

FIG. 4 illustrates an example operating environment for offloading operations from a processing unit to multiple hardware accelerators. FIG. 4 shows operating environment 400, which further includes processing unit 405, memory adaptor bridge 410, memory 415, hardware accelerators (HWAs) 420 and 425, and compare logic 430. In operation, the components of operating environment 400 operate in a redundant scenario whereby memory adaptor bridge 410 can write the same operands to both HWAs 420 and 425 to validate a result of a function performed on the operand by HWAs 420 and 425.

Processing unit 405 may be configured to execute code that includes one or more computations and mathematical operations. Processing unit 405 executes such software from a memory (e.g., memory 415) to enable functionality of the code. To do so, processing unit 405 attempts to read from and write to memory 415 according to the application software. However, processing unit 405 may not natively support some operations required to complete the execution of the application software. For example, native ISA of processing unit 405 may not support computations on some mathematical equations, or operands. Such operations may instead require the operands to be offloaded for computation by another processing device, hardware accelerator, or the like.

HWAs 420 and 425 can be employed to perform computations on operands not natively supported by or too complex for processing unit 405. HWAs 420 and 425 can perform one or more functions, such as trigonometric functions, differential equations, and time-invariant functions, among other computations and deterministic functions. In some instances, HWAs 420 and 425 may be configured to perform only one function, however, in other instances, they can be configured to perform any number of functions. Each function performable by HWAs 420 and 425 can correspond to one or more locations within memory 415. In operation, when processing unit 405 attempts to read from and/or write to one of the locations corresponding to HWAs 420 and 425, compute circuitry of HWAs 420 and 425 can be enabled to perform the one or more functions on the operand that processing unit 405 attempts to read/write.

Memory bridge adaptor 410 is included and is coupled between both processing unit 405 and memory 415 and also coupled to HWAs 420 and 425 to facilitate compute offloading from processing unit 405 to HWAs 420 and 425. In various instances, memory bridge adaptor 410 has logic circuitry (e.g., process 200 of FIG. 2) configured to identify the attempts from processing unit 405 to read from and write to locations in memory 415. If processing unit 405 attempts to access a location in memory 415 mapped to HWA 420 and/or HWA 425, memory bridge adaptor 410 can write the operand, data, instruction, and the like to a location accessible by HWAs 420 and 425 for computation.

Memory bridge adaptor 410 can be configured to write the operand to one or more locations. For example, memory adaptor bridge 410 can write the operand to one location accessible by both HWAs 420 and 425 (e.g. memory 415), or memory adaptor bridge 410 can write the operand to locations individually accessible by respective ones of HWAs 420 and 425 (e.g., registers located within each of HWA 420 and HWA 425). Moreover, memory bridge adaptor 410 can write the operand at the same time or within a few CPU clock cycles of each other. This may be referred to herein as lock-step mode whereby HWAs 420 and 425 are used for redundancy to provide safety and validation of computations, for example. Thus, HWAs 420 and 425 perform the same one or more functions on the operand to potentially generate the same result.

Operating environment 400 further includes compare logic 430 representative of any circuitry, logic devices, fixed-purpose hardware, or any combination or variation thereof configured to perform a comparison between the results produced by HWAs 420 and 425. In the case where HWAs 420 and 425 produce the same results, compare logic 430 can provide result 435, representative of the result/value of the function performed on the operand written to HWAs 420 and 425, to memory adaptor bridge 410. Then, memory adaptor bridge 410 can write result 435 in a location accessible by processing unit 405 (e.g., memory 415). The location to which memory adaptor bridge 410 writes result 435 may be a different location than the location processing unit 405 initially attempted to write the operand. Regardless, processing unit 405 can read result 435 from memory 415 via memory adaptor bridge 410. Alternatively, in the case where HWAs 420 and 425 produce different results using the same functions on the operand, compare logic 430 can provide result 435, representative of an error or an invalid value, to memory adaptor bridge 410. Accordingly, memory adaptor bridge 410 can either write an error in the respective location in memory 415, or it can leave the location empty.

In some cases, compare logic 430 exists externally from the architecture of memory adaptor bridge 410, as shown in operating environment 400. However, in other cases, compare logic 430 may be included as part of memory adaptor bridge 410. In such cases, the logic or components configured to perform the comparison of the outputs of HWAs 420 and 425 may be part of the logic circuitry of memory adaptor bridge 410 that is configured to perform compute offloading processes. Alternatively, the logic performable by memory adaptor bridge 410 may be implemented in a segregated manner with respect to each other.

Following the example where result 435 represents the value of the function performed on the operand by HWAs 420 and 425, processing unit 405 can attempt a read of the value in memory 415. Memory adaptor bridge 410 can supply processing unit 405 with result 435 immediately, or it can supply processing unit 405 with result 435 after a number of clock cycles. In instances embodying the latter scenario, processing unit 405 may use no operation (NOP) instructions to delay a read attempt. Alternatively, or in addition, one or both of HWAs 420 and 425 or memory adaptor bridge 410 can stall a bus of processing unit 405 until the result of the comparison is ready to be read by processing unit 405.

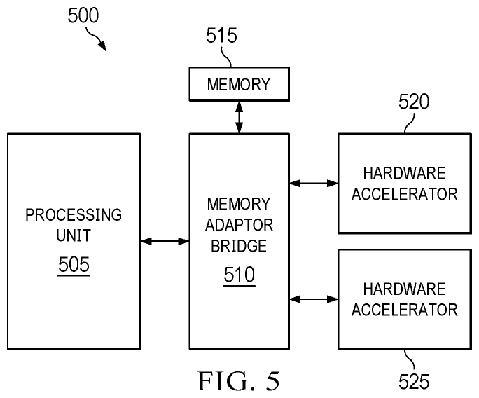

FIG. 5 illustrates an example operating environment for offloading operations from a processing unit to multiple hardware accelerators. FIG. 5 shows operating environment 500, which includes processing unit 505, memory adaptor bridge 510, memory 515, and hardware accelerators (HWAs) 520 and 525. In operation, the components of operating environment 500 operate in a non-redundant scenario whereby memory adaptor bridge 510 can write the same operand to HWAs 520 and 525 for computation to obtain different results or to employ one hardware accelerator over another when one of the hardware accelerators is busy. In some examples, a single operating environment can be selectably configured to operate in the manner of operating environment 400 for redundancy or safety or in the manner of operating environment 500 for efficiency and performance depending on the application by changing the operation of the memory adaptor bridge.

In operation, processing unit 505 may be configured to execute code that includes one or more computations and mathematical operations. Processing unit 505 executes instructions and data from a memory (e.g., memory 515) to enable functionality of the code. To do so, processing unit 505 attempts to read from and write to memory 515 according to the code. However, processing unit 505 may not natively support some operations required to complete the execution of the code. For example, native ISA of processing unit 505 may not support computations on some mathematical equations, or operands. Such operations may instead require the operands to be offloaded for computation by another processing device, hardware accelerator, or the like.

HWAs 520 and 525 can be employed to perform computations on operands not natively supported by or too complex for processing unit 505. HWAs 520 and 525 can perform one or more functions, such as trigonometric functions, differential equations, and time-invariant functions, among other computations. In some instances, HWAs 520 and 525 may be configured to perform only one function, however, in other instances, they can be configured to perform any number of functions, including functions different from one another. Each function performable by HWAs 520 and 525 can correspond to one or more locations within memory 515. When processing unit 505 attempts to read from and/or write to one of the locations corresponding to HWAs 520 and 525, compute circuitry of HWAs 520 and 525 can be enabled to perform the one or more functions on the operand that processing unit 505 attempts to read/write to memory 515.

Memory bridge adaptor 510 is coupled between both processing unit 505, memory 515 and to HWAs 520 and 525 to facilitate compute offloading from processing unit 505 to one of HWAs 520 and 525 in a non-lock step mode when redundancy or validation of results is unnecessary (i.e., a non-redundant scenario whereby one of multiple HWAs can be employed to continue software execution without interruption or delay). In various instances, memory bridge adaptor 510 has logic circuitry configured to identify the attempts from processing unit 505 to read from and write to locations in memory 515. If processing unit 505 attempts to access a location in memory 515 mapped to HWA 520 and/or HWA 525, memory bridge adaptor 510 can write the operand to a location accessible by at least one of HWAs 520 and 525 for computation.

Before writing the operand to a memory location for use by one of HWAs 520 and 525, memory adaptor bridge 510 can be configured to identify a status of HWAs 520 and 525. The status can refer to whether the HWA is busy or not. In the case that memory adaptor bridge 510 identifies that HWA 520 is busy, memory adaptor bridge 510 can write the operand to a location accessible by HWA 525. Alternatively, if memory adaptor bridge 510 identifies that HWA 525 is busy, memory adaptor bridge 510 can write the operand to a location accessible by HWA 520. In the case that both HWA 520 and HWA 525 are busy, memory adaptor bridge 510 can interrupt one of HWA 520 and HWA 525 and provide the operand to the respective HWA to perform a function on the operand. Memory adaptor bridge 510 may determine which HWA to interrupt based on a priority or importance of the functions being performed on HWAs 520 and 525. The interrupted HWA can later repeat an interrupted function after performing the function and producing a result of the function performed on the operand.

Then, either HWA 520 or HWA 525 can perform a function on the operand and produce a result. The HWA can store the result in another memory location accessible by the respective HWA, such as a memory on the HWA or a location on memory 515. Memory adaptor bridge 510 can read the result and write the result to a further location in memory 515 accessible by processing unit 505. Processing unit 505 can then attempt to read the result from memory 515, and memory adaptor bridge 510 can allow processing unit 505 to access the memory location holding the result so that processing unit 505 can continue executing the software or use the result for another process.

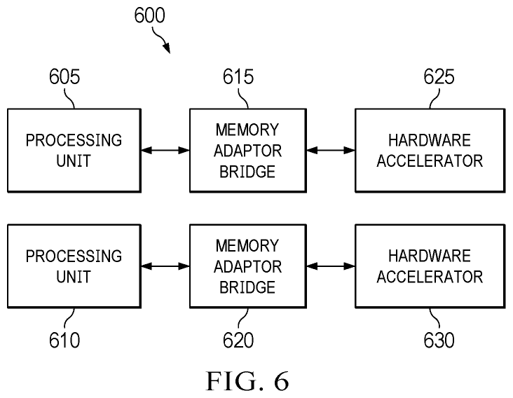

FIG. 6 illustrates an example operating environment for offloading operations from multiple processing units to multiple hardware accelerators. FIG. 6 shows operating environment 600, which includes processing units 605 and 610, memory adaptor bridges 615 and 620, and hardware accelerators (HWAs) 625 and 630. In operation, the components of operating environment 600 operate in a split mode whereby each processing unit can operate with individual ones of HWAs to perform compute offloading.

In operation, processing units 605 and 610 are representative of two or more processing units, nodes, cores of a central processing unit (CPU) configured to execute code that includes one or more computations and mathematical operations. Processing units 605 and 610 execute instructions and data of the code from one or more memories (not shown). Each of processing units 605 and 610 may utilize individual memories, or they may execute software from the same memory to enable functionality of the code. Regardless, in executing the software, processing units 605 and 610 attempt to read from and write to memory according to code. However, the processing units may not natively support some operations required to complete the execution of the code. For example, native ISA of the processing units or CPU may not support computations on some mathematical equations, or operands. Such operations may instead require the operands to be offloaded for computation by another processing device, hardware accelerator, or the like.

HWAs 625 and 630 can be employed to perform computations on operands not natively supported by or too complex for the processing units. HWAs 625 and 630 can perform one or more functions, such as trigonometric functions, differential equations, and time-invariant functions, among other computations and deterministic functions. In some instances, HWAs 625 and 630 may be configured to perform only one function, however, in other instances, they can be configured to perform any number of functions, including functions different from one another. Each function performable by HWAs 625 and 630 can correspond to one or more locations in a memory. When processing unit 605 attempts to read from and/or write to one of the locations corresponding to HWA 625, compute circuitry of HWA 625 can be enabled to perform the one or more functions on the operand that processing unit 605 attempts to read/write to memory. Similarly, when processing unit 610 attempts to access a location mapped to HWA 630, compute circuitry of HWA 630 can perform the one or more functions on the operand.

Memory bridge adaptors 615 and 620 are coupled between processing units 605 and 610, respectively, between HWAs 625 and 630, respectively, and between one or more memories. Memory bridge adaptors 615 and 620 can facilitate compute offloading from the processing units to HWAs in various scenarios. For example, the individual subsystems of processing units, memory adaptor bridges, and HWAs can be used to increase performance and efficiency of an overarching CPU. In another example, the individual subsystems can be used to validate results produced by a hardware accelerator of another subsystem to provide safety and redundancy. In various instances, memory bridge adaptors 615 and 620 have logic circuitry configured to identify respective attempts from processing units 605 and 610 to read from and write to locations in memory (not shown). In some cases, a single memory bridge adaptor can be used to perform compute offloading techniques between multiple CPUs and HWAs.

In response to the attempts to write operands to locations in memory associated with functions of HWAs 625 and 630, memory adaptor bridges 615 and 620 can write the operands to respective memory locations accessible by HWAs 625 and 630. Each of the HWAs can perform a function on a respective operand to produce a result. Then, memory adaptor bridges 615 and 620 can read the results and write them to locations in the memory accessible by processing units 605 and 610, respectively. Processing units 605 and 610 can then attempt to read the results from the memory locations and use the results to continue executing the software or for another purpose.

In some instances, processing units 605 and 610 may be individual processing cores on a single microcontroller or other device. The processing cores can each interface with tightly coupled memory, random access memory, and other types of memory. The processing cores can also interface with one or more of the same memories.

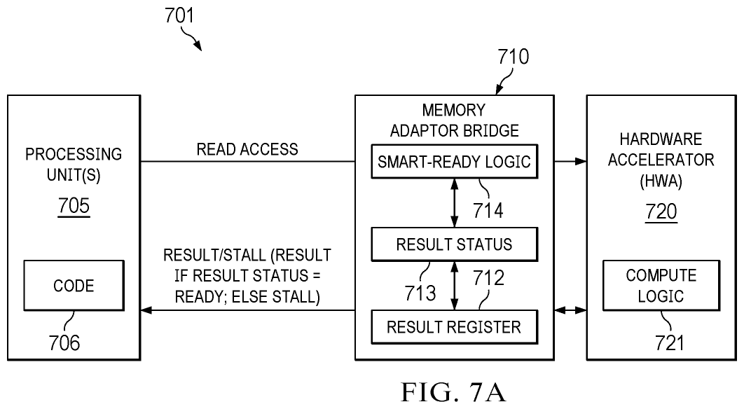

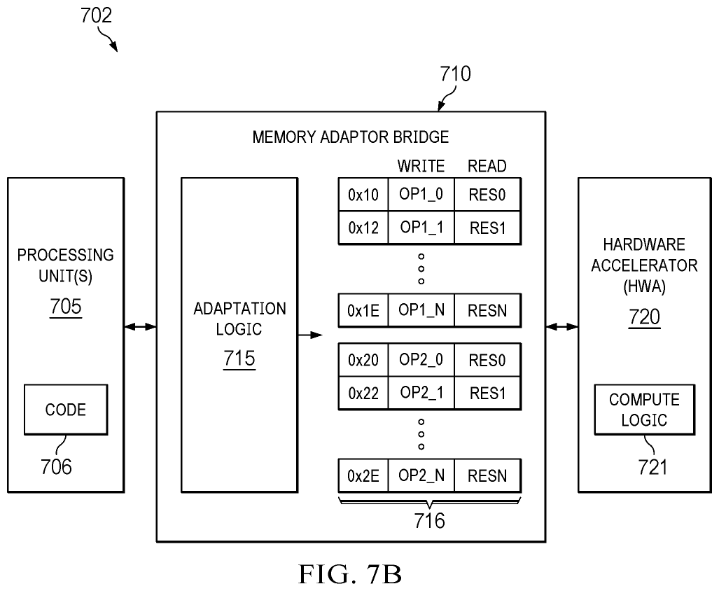

FIGS. 7A and 7B illustrate example operating environments wherein components can perform compute offloading. FIG. 7A shows operating environment 701, which includes processing unit(s) 705, memory adaptor bridge 710, and hardware accelerator (HWA) 720. FIG. 7B shows operating environment 702, which also includes processing unit(s) 705, memory adaptor bridge 710, and HWA 720. Processing units 705 may include any of processing unit 105, processing unit 405, processing unit 505, processing unit 605, and/or processing unit 610. Memory adaptor bridge 710 include any of memory adaptor bridge 110, memory adaptor bridge 410, memory adaptor bridge 510, memory adaptor bridge 615, and/or memory adaptor bridge 610 and may execute different logic to implement compute offloading processes described herein. HWA 720 may include any of HWA 115, HWA 420, HWA 425, HWA 520, HWA 525, HWA 625, and/or HWA 630.

In both operating environments 701, and 702, the components shown can, together, offload computations from processing unit(s) 705 to HWA 720 through memory adaptor bridge 710. Processing unit(s) 705 is representative of one or more processors, processing nodes/cores, or processing devices, capable of executing code 706. In some cases, processing unit(s) 705 is one or more cores of a multi-core central processing unit (CPU). Processing unit(s) 705 can interface with memory adaptor bridge 710 to write to and read from a memory (not shown). Each time processing unit(s) 705 attempts to access the memory, memory adaptor bridge 710 can route an operand requested to be written or read directly to the memory or to HWA 720 using logic circuitry or other processing devices.

Referring first to operating environment 701 of FIG. 7A, processing unit(s) 705 attempts, during execution of code 706, to read an operand from a location in memory (not shown) mapped to a function of HWA 720. Memory adaptor bridge 710, in response to this attempt, allows processing unit(s) 705 to read the operand from the memory location storing the operand.

HWA 720 includes compute logic 721, which HWA 720 can utilize to perform various functions on operands offloaded from processing unit(s) 705. However, some operations performed by HWA 720 may take several clock cycles to complete before a result of a function performed on an operand is available for processing unit(s) 705 to read. Thus, in some embodiments, processing unit(s) 705 may utilize NOP cycles, per code 706, to delay a read attempt of the result produced by HWA 720. However, this NOP scheme may introduce undesirable variable delay depending on which function is identified by memory adaptor bridge 710 to be performed by HWA 720 in response to the attempt, by processing unit(s) 705, to read the operand. In other embodiments, to avoid such an NOP scheme, memory adaptor bridge 710 may include smart-ready logic 714. With smart ready-logic 714, representative of logic circuitry or other hardware or software, memory adaptor bridge 710 may automatically stall access, by processing unit(s) 705, to a register of result register 712 (or another location accessible by processing unit(s) 705) if the result is invalid or not available. Smart-ready logic 714 can be configured to identify the function and corresponding memory address for the function of HWA 720, including which location within result register 712 the result is located. Smart-ready logic 714 can also be configured to identify result status 713 of the function being performed by compute logic 721 of HWA 720. Result status 713 may indicate that the function is in-progress by HWA 720 or that the function is complete and the result is ready, among other statuses. If result status 713 indicates that the function is in-progress, memory adaptor bridge 710 can stall operations of processing unit(s) 705.

The following software/firmware programming may be utilized with program inserted delays (e.g., NOP) and without use of smart-ready logic 714 in the example shown in FIG. 7A:

WR_MEM_64(0x000040040,(0xffffffff3dcccccd)); //sin(2*pi*0.1)
asm(“ NOP”); //As many NOP as necessary to adjust the delay
. . .
asm(“ NOP”);
read_long_result0 = RD_MEM_64(0x00040280); //read
RESULT_REGISTER

The following software/firmware programming may be utilized with smart-ready logic 714 in the example shown in FIG. 7A:

WR_MEM_64(0x000040040,(0xffffffff3dcccccd)); //sin(2*pi*0.1)
read_long_result0 = RD_MEM_64(0x00040280); //read RESO

In some embodiments, ordering of processing unit(s) 705 writes and reads may be specified to ensure correct operation of compute offloading processes described herein (e.g., write of operand followed by result read). For a strongly ordered processing unit/CPU architecture, write and read memory accesses from processing unit(s) 705 may occur in the order as written in code 706. In this case, no additional mechanism is needed for ordering. Operand and result registers may be at different addresses. Smart-ready logic 714 can ensure that processing unit(s) 705 is stalled from accessing memory until the result is ready, ensuring optimal program code and no corruption.

The following software/firmware programming may also be utilized with smart-ready logic 714 in the example shown in FIG. 7A:

WR_MEM_64(0x000040040,(0xffffffff3dcccccd)); //sin(2*pi*0.1)
read_long_result0 = RD_MEM_64(0x00040280); //read
RESULT_REGISTER

Referring next to FIG. 7B, memory adaptor bridge 710 can be configured with different logic, adaptation logic 715 and a different memory mapping, memory map 716, implemented using adaptation logic 715 representative of locations and associated functions in memory. In some embodiments adapted for use with non-strongly ordered processing unit/CPU architecture, writes and reads by processing unit(s) 705 may occur in a different order than written in code 706 as long as program intent is satisfied. To ensure correct operation of compute offloading processes with non-strongly ordered architectures, two implementation approaches may be taken. A first manner of implementation in this regard may include using barrier instructions, which provides that processing unit(s) 705 writes and reads to one of the registers located in memory map 716 are issued in order without compiler optimizations.

For example, the following software/firmware programming may be utilized for the aforementioned first manner of implementation for non-strongly ordered architectures in the example shown in FIG. 7B:

WR_MEM_64(0x000040040,(0xffffffff3dcccccd)); //sin(2*pi*0.1)
asm(“ DSB”);
read_long_result0 = RD_MEM_64(0x00040280); //read
RESULT_REGISTER

A second manner of implementation for compute offloading with processing unit(s) 705 having non-strongly ordered architecture includes aliasing result registers denoted in memory map 716 to operand registers of memory map 716 based on read and write access. In this example, function registers (e.g., 0x10) and result registers (e.g., RES0) may be mapped to the same operand address (e.g., OP1_0) as shown by memory map 716. In response to an attempt by processing unit(s) 705 to write an operand to a location mapped to a location associated with a function of HWA 720, according to memory map 716, adaptation logic 715 of memory adaptor bridge 710 can write to the corresponding operand location within memory map 716. Subsequently, in an attempt, by processing unit(s) 705, to read the operand from a respective result register, memory adaptor bridge 710 can read the result from the result register following memory map 716. In this case, since the write and read by processing unit(s) 705 is to/from the same address, adaptation logic 715 of memory adaptor bridge 710 can perform write and read in a specific order.

For example, the following software/firmware programming may be utilized for the aforementioned second manner of implementation for non-strongly ordered architectures in the example shown in FIG. 7B:

WR_MEM_64(0x000040040,(0xffffffff3dcccccd)); //sin(2*pi*0.1)
read_long_result0 = RD_MEM_64(0x00040040); //read
RESULT_REGISTER

While some examples provided herein are described in the context of a compute offloading system, architecture, or environment, the compute offloading methods, techniques, and systems described herein are not limited to such examples and may apply to a variety of other processes, systems, applications, devices, and the like. Aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Unless the context clearly requires otherwise, throughout the description and the claims, the words “comprise.” “comprising.” and the like are inclusive meaning “including, but not limited to.” In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A. A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The phrases “in some examples,” “according to some examples,” “in the examples shown,” “in other examples,” and the like generally mean the particular feature, structure, or characteristic following the phrase is included in at least one implementation of the present technology, and may be included in more than one implementation. In addition, such phrases do not necessarily refer to the same example or different examples.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

1. A system, comprising;
a processing unit; and
a memory adaptor bridge coupled to the processing unit and configured to:
in response to an attempt by the processing unit to write an operand to a memory location mapped to a function of a hardware accelerator, write the operand to a different memory location accessible by the hardware accelerator;
obtain a result of the function performed on the operand by the hardware accelerator; and
provide the result to a memory location accessible by the processing unit.

2. The system of claim 1, wherein the processing unit comprises a core of a multi-core central processing unit (CPU).

3. The system of claim 2, wherein the hardware accelerator resides onboard the CPU.

4. The system of claim 1, wherein the result comprises a first result, wherein the hardware accelerator comprises a first hardware accelerator, and wherein the memory adaptor bridge is further configured to:
in response to the attempt by the processing unit to write the operand to the memory location mapped to the function of the hardware accelerator, write the operand to a different memory location accessible by a second hardware accelerator that provides redundancy with respect to the first hardware accelerator;
obtain a second result of the function performed on the operand by the second hardware accelerator; and
provide a result of a comparison of the first result and the second result to the memory location accessible by the processing unit.

5. The system of claim 4, wherein based on a determination that a value of the first result matches a value of the second result, the result of the comparison comprises the value, and wherein based on a determination that the value of the first result does not match the value of the second result, the result of the comparison comprises an invalid value.

6. The system of claim 4, wherein the comparison of the first result and the second result is performed by a logic component external to the memory adaptor bridge.

7. The system of claim 6, wherein the system further comprises a memory coupled to the memory adaptor bridge, and wherein the different memory location accessible by the hardware accelerator is external to the memory.

8. The system of claim 1, wherein the result comprises a first result, wherein the hardware accelerator comprises a first hardware accelerator, and wherein the memory adaptor bridge is further configured to:
in response to the attempt by the processing unit to write the operand to the memory location mapped to the function of the hardware accelerator, write the operand to a different memory location accessible by a second hardware accelerator based on a determination that the first hardware accelerator is unavailable;
obtain a second result of the function performed on the operand by the second hardware accelerator; and
provide the second result of the function to the memory location accessible by the processing unit.

9. The system of claim 1, wherein the hardware accelerator is configured to perform the function in a predetermined number of clock cycles after the memory adaptor bridge writes the operand to the different memory location accessible by the hardware accelerator.

10. The system of claim 9, wherein the memory adaptor bridge is further configured to delay attempts by the processing unit other than the attempt to write the operand to the memory location mapped to the function of the hardware accelerator until the memory adaptor bridge provides, after the predetermined number of clock cycles, the result of the function to the memory location accessible by the processing unit.

11. A method, comprising:
receiving, at a memory adaptor bridge, an attempt by a processing unit to write an operand to a memory location mapped to a function a hardware accelerator;
in response to the attempt by the processing unit to write the operand to the memory location mapped to the function a hardware accelerator, writing the operand to a different memory location accessible by the hardware accelerator;
obtaining a result of the function performed on the operand by the hardware accelerator; and
providing the result of the function to a memory location accessible by the processing unit.

12. The method of claim 11, wherein the processing unit comprises a core of a multi-core central processing unit (CPU).

13. The method of claim 12, wherein the hardware accelerator resides onboard the CPU.

14. The method of claim 11, wherein the result comprises a first result and wherein the hardware accelerator comprises a first hardware accelerator.

15. The method of claim 14, further comprising:
in response to the attempt by the processing unit to write the operand to the memory location mapped to the function of the hardware accelerator, writing the operand to a different memory location accessible by a second hardware accelerator that provides redundancy with respect to the first hardware accelerator;
obtaining a second result of the function performed on the operand by the second hardware accelerator; and
providing a result of a comparison of the first result and the second result to the memory location accessible by the processing unit.

16. The method of claim 15, comprising based on determining that a value of the first result matches a value of the second result, providing the value of the first result or the value of the second result as the result of the comparison, and based on determining that the value of the first result does not match the value of the second result, providing an invalid value as the result of the comparison.

17. The method of claim 15, wherein the comparison of the first result and the second result is performed by a logic component external to the memory adaptor bridge.

18. The method of claim 14, further comprising:
in response to the attempt by the processing unit to write the operand to the memory location mapped to the function of the hardware accelerator, writing the operand to a different location accessible by a second hardware accelerator based on determining that the first hardware accelerator is unavailable;
obtaining a second result of the function performed on the operand by the second hardware accelerator; and
providing the second result of the function to the memory location accessible by the processing unit.

19. The method of claim 11, further comprising delaying an attempt by the processing unit to read the result of the function from the memory location accessible by the processing unit for a predetermined number of clock cycles.

20. A memory adaptor bridge, comprising:
first circuitry configured to, in response to an attempt by a processing unit to write an operand to a memory location mapped to a function of a hardware accelerator, write the operand to a different memory location accessible by the hardware accelerator; and
second circuitry configured to:
obtain a result of the function performed on the operand by the hardware accelerator; and
provide the result of the function to a memory location accessible by the processing unit.
